(19) United States
(12) Patent Application Publication
(10) Pub. No.: US 2004/0061772 A1
(43) Pub. Date: Apr. 1, 2004

(54) Method, apparatus and program for text image processing

(76) Inventor: Kouji Yokouchi, Kanagawa-ken (JP)

Correspondence Address: BIRCH STEWART KOLASCH & BIRCH, PO BOX 747, FALLS CHURCH, VA, 22040-0747, US

(21) Appl. No.: 10/669,363

(22) Filed: Sep. 25, 2003

(30) Foreign Application Priority Data
Sep. 26, 2002 (JP) 281511/2002

(51) Int. Cl. H04N 7/14

(52) U.S. Cl. 348/14.01; 348/14.02

(57) ABSTRACT

Characters written on a text medium such as paper can be obtained easily as information. The text medium having the characters written thereon is photographed by a camera phone. A text image data set is obtained in this manner, and sent to a text image processing apparatus. Correction means corrects aberration and the like of a camera lens of the camera phone, and obtains a corrected text image data set. Character recognition means carries out character recognition processing on the corrected text image data set by using an OCR technique, and obtains a character code data set. The character code data set is sent to the camera phone and displayed as text on a liquid crystal display monitor of the camera phone.

### BACKGROUND OF THE INVENTION

1. Field of the Invention

The present invention relates to a method and an apparatus for carrying out processing on text image data representing a text image. The present invention also relates to a program that causes a computer to execute the text image processing method.

2. Description of the Related Art

A system is known wherein image data obtained by an imaging device such as a digital camera or by reading images recorded on a film with a scanner are reproduced by an output device such as a printer or a monitor. When the image data are reproduced, a quality of a reproduced image can be improved by carrying out various kinds of image processing such as density conversion processing, white balance processing, gradation conversion processing, chroma enhancement processing, and sharpness processing on the image data.

Meanwhile, the spread of mobile phones is remarkable, and camera-embedded mobile terminals such as camera phones having imaging means for obtaining image data by photography (see Japanese Unexamined Patent Publications No. 6(1994)-233020, 9(1997)-322114, 2000-253290, and U.S. Pat. No. 6,337,712 for example) are spreading. By using such a camera-embedded mobile terminal, preferable image data obtained by photography can be used as wallpaper of a screen of the terminal. Furthermore, image data obtained by a user through photography can be sent to a mobile terminal such as a mobile phone or a PDA owned by his/her friend by being attached to an E-mail message. Therefore, for example, in the case where a user needs to cancel an appointment or the user seems likely to be late for meeting, the user can photograph himself/herself with a sorrowful expression and can send the photograph to his/her friend. In this manner, the user can let his/her friend know a situation of the user, which is convenient for communication with the friend.

An image server has also been proposed, with use of an image processing apparatus for obtaining processed image data by carrying out various kinds of image processing on image data obtained by photography with a camera phone. Such an image server can receive image data sent from a camera-embedded mobile terminal and sends processed image data obtained by carrying out image processing on the image data to a destination specified by a user using the camera-embedded mobile terminal. Furthermore, the image server can store the image data and can send the image data to the camera-embedded mobile terminal upon a request input from the mobile terminal. By carrying out the image processing on the image data in the image server, a high-quality image can be used as wallpaper for a screen of the mobile terminal and can be sent to friends.

Meanwhile, in the case where characters written on a medium such as paper or blackboard (hereinafter referred to as a text medium) are output as information, text data are generated by typing the characters or text image data are generated by photography of the text medium. However, typing is a troublesome operation. Moreover, although the characters included in the text image data can be read by reproduction of the text image data, the characters are not easy to see if image processing such as white balance processing is carried out on the text image data.

Furthermore, since a size of readable characters is limited, characters included in a text image becomes too small and are not easy to see if a text medium such as a blackboard having a large size is photographed.

### SUMMARY OF THE INVENTION

The present invention has been conceived based on consideration of the above circumstances. An object of the present invention is therefore to easily output information of characters written on a text medium such as paper.

A text image processing method of the present invention comprises the steps of:

receiving an input of a text image data set representing a text image obtained by photography of a text medium on which characters are written;

obtaining a character code data set by converting the characters included in the text image into codes through character recognition processing on the text image data set; and

outputting the character code data set.

The character recognition processing refers to an OCR technique whereby the character code data set is obtained through pattern recognition carried out on the text image.

In the text image processing method of the present invention, the text image data set may be generated as a composite of partial text image data sets obtained by partially photographing the text medium while dividing the text medium into parts.

In the text image processing method of the present invention, the text image data set may be generated as a composite of frame image data sets representing predetermined frames cut from a moving image data set obtained by filming the text medium.

The predetermined frames refer to frames enabling restoration of the text image data set representing the entire text image by generating the composite image from the frame image data sets. Filming the text medium refers to photographing the text medium while moving the portion of the text medium which is being photographed.

In the text image processing method of the present invention, the text image data set may be stored so that link information can be output together with the character code data set, for representing where the text image data set, from which the character code data set was obtained, is stored.

Furthermore, in the text image processing method of the present invention, the character code data set may be converted into a voice data set so that the voice data set can be output instead of or together with the character code data set.

In the text image processing method of the present invention, the text image data set obtained by photography of the text medium with a camera-embedded mobile terminal may be received from the camera-embedded mobile terminal. In this case, the character code data set may be sent to the camera-embedded mobile terminal.

A text image processing apparatus of the present invention comprises:

input means for receiving an input of a text image data set representing a text image obtained by photography of a text medium on which characters are written;

character recognition means for obtaining a character code data set by converting the characters included in the text image into codes through character recognition processing on the text image data set; and

output means for outputting the character code data set.

The text image processing apparatus of the present invention may further comprise composition means for obtaining the text image data set through generation of a composite image from partial text image data sets obtained by partially photographing the text medium while dividing the text medium into parts.

Furthermore, the text image processing apparatus of the present invention may further comprise cutting means for cutting predetermined frames from a moving image data set obtained by filming the text medium; and

composition means for obtaining the text image data set through generation of a composite image from frame image data sets representing the predetermined frames cut by the cutting means.

Moreover, the text image processing apparatus of the present invention may further comprise storage means for storing the text image data set; and

link information generation means for generating link information representing where the text image data set, from which the character code data set was obtained, is stored so that

the output means can output the link information together with the character code data set.

In addition, the text image processing apparatus of the present invention may further comprise voice conversion means for converting the character code data set into a voice data set so that

the output means can output the voice data set instead of or together with the character code data set.

The text image processing apparatus of the present invention may further comprise communication means for receiving the text image data set obtained by photography of the text medium with a camera-embedded mobile terminal and sent from the camera-embedded mobile terminal, and for sending the character code data set to the camera-embedded mobile terminal.

The text image processing method of the present invention may be provided as a program for causing a computer to execute the text image processing method.

According to the present invention, the input of the text image data set is received, and the characters included in the text image are converted into the character codes by the character recognition processing on the text image data set. The character code data set obtained in the above manner is then output. Therefore, as long as the text image data set is obtained with a digital camera or the like by photography of the characters written on the text medium such as paper or a blackboard, the characters written on the text medium can be output as text information represented by the character code data set, as a result of application of the text image processing method of the present invention to the text image data set. Consequently, the characters written on the text medium can be displayed as text.

By obtaining the text image data set as the composite of the partial text image data sets obtained by photographing each of the parts of the text medium, the characters written over the entire text medium having a wide area such as a blackboard can be obtained as the character code data set.

Furthermore, if the predetermined frames are cut from the moving image data set obtained by filming the text medium and if the text image data set is obtained as the composite of the frame image data sets representing the predetermined frames, the characters written over the entire text medium having a wide area such as a blackboard can be obtained as the character code data set.

By outputting the link information representing where the text image data set is stored together with the character code data set, the text image data set from which the character code data set was obtained can be referred to, according to the link information. Therefore, the text image represented by the text image data set can be compared to the text represented by the character code data set. In this manner, whether or not the character code data set has errors therein can be confirmed easily.

Moreover, by converting the character code data set into the voice data set and by outputting the voice data set instead of the character code data set, an illiterate person or a vision-impaired person can understand the content represented by the characters written on the text medium.

If the text image data set is obtained by photography of the text medium with a camera-embedded mobile terminal, the text medium can be easily photographed, and the character code data set representing the text image can be obtained from the text image data set.

### BRIEF DESCRIPTION OF THE DRAWINGS

FIG. 1 is a block diagram showing the configuration of a text image communication system adopting a text image processing apparatus of a first embodiment of the present invention;

FIG. 2 is a flow chart showing procedures carried out in the first embodiment;

FIG. 3 is a block diagram showing the configuration of a text image communication system adopting a text image processing apparatus of a second embodiment of the present invention;

FIG. 4 is a flow chart showing procedures carried out in the second embodiment;

FIG. 5 is a block diagram showing the configuration of a text image communication system adopting a text image processing apparatus of a third embodiment of the present invention;

FIGS. 6A and 6B are diagrams for explaining generation of partition information;

FIG. 7 is a flow chart showing procedures carried out in the third embodiment;

FIG. 8 is a block diagram showing the configuration of a text image communication system adopting a text image processing apparatus of a fourth embodiment of the present invention;

FIGS. 9A and 9B are diagrams for explaining addition of marks; and

FIG. 10 is a flow chart showing procedures carried out in the fourth embodiment.

### DESCRIPTION OF THE PREFERRED EMBODIMENTS

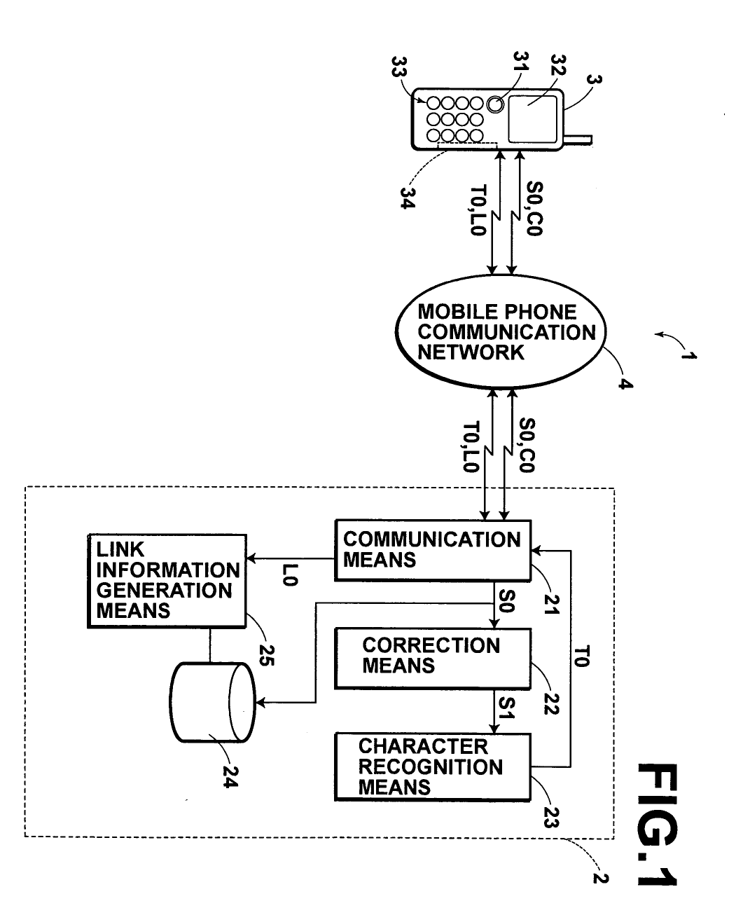

Hereinafter, embodiments of the present invention will be explained with reference to the accompanying drawings. FIG. 1 is a block diagram showing the configuration of a text image communication system adopting a text image processing apparatus of a first embodiment of the present invention. As shown in FIG. 1, the text image communication system in the first embodiment exchanges data between a text image processing apparatus 2 and a camera-embedded mobile phone 3 (hereinafter referred to as a camera phone 3) via a mobile phone communication network 4.

The text image processing apparatus 2 comprises communication means 21, correction means 22, character recognition means 23, storage means 24, and link information generation means 25. The communication means 21 carries out data communication with the camera phone 3 via the mobile phone communication network 4. The correction means 22 obtains a corrected text image data set S1 by correcting distortion caused by aberration of a camera lens or the like of the camera phone 3 and occurring on a text image represented by a text image data set S0 sent from the camera phone 3. The character recognition means 23 obtains a character code data set TO by coding characters included in the text image represented by the corrected text image data set S1, through character recognition processing on the corrected text image data set S1. The storage means 24 stores various kinds of information such as the corrected text image data set S1. The link information generation means 25 generates link information L0 representing the URL of the corrected text image data set S1 when the corrected text image data set S1 is stored in the storage means 24.

The camera phone 3 can send not only the text image data set S0 but also image data representing people or scenery, for example. Therefore, text image information C0 is sent from the camera phone 3 together with the text image data set S0, to represent the fact that the data sent from the camera phone 3 represents the text image. Therefore, the text image processing apparatus 2 can carry out the character recognition processing by recognizing the fact that the data sent from the camera phone 3 are the text image data set S0, in the case where the data are sent together with the text image information C0. The text image information C0 includes model information regarding the camera phone 3.

The correction means 22 corrects the distortion occurred in the text image due to aberration of the camera lens, for example. The storage means 24 has correction information in accordance with the model of the camera phone 3. Therefore, the correction means 22 obtains the correction information corresponding to the mode of the camera phone 3 that obtained the text image data set S0, based on the model information of the camera phone 3 included in the text image information C0 sent from the camera phone 3 together with the text image data set S0. Based on the correction information, the correction means 22 corrects the distortion of the text image represented by the text image data set S0, and obtains the corrected text image data set S1.

The character recognition means 23 obtains the character code data set T0 from the corrected text image data set S1, by using an OCR technique for obtaining character codes through pattern recognition.

The character code data set T0 is sent from the communication means 21 to the camera phone 3 via the mobile phone communication network 4, together with the link information L0 comprising the URL of where the corrected text image data set S1 is stored. The character code data set T0 is displayed as text on the camera phone 3.

The camera phone 3 comprises a camera 31 for obtaining image data representing a subject by photography of the subject, a liquid crystal display monitor 32 for displaying images and commands, operation buttons 33 comprising ten keys and the like, and a memory 34 for storing various kinds of information.

A user of the camera phone 3 obtains the text image data set S0 representing the text image by photography of the characters written on a text medium such as paper or a blackboard. In response to a transfer operation of the buttons 33 by the user, the text image data set S0 is sent to the text image processing apparatus 2 via the mobile phone communication network 4. At this time, the text image information C0 representing the fact that the image data set is the text image data set is also sent together with the text image data set S0.

The character code data set T0 sent from the text image processing apparatus 2 is displayed as the text on the liquid crystal display monitor 32. The link information L0 is also displayed as the URL on the monitor 32.

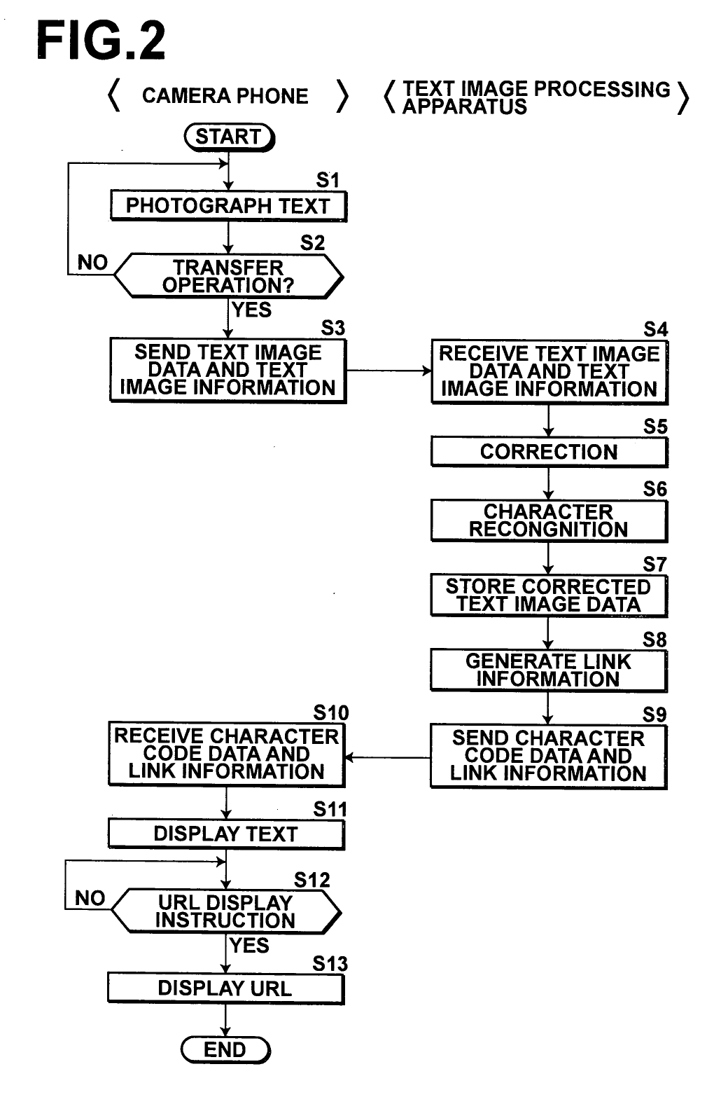

The operation of the first embodiment will be explained next. FIG. 2 is a flow chart showing procedures carried out in the first embodiment. The user photographs the characters written on the text medium such as paper or blackboard by using the camera phone 3, and obtains the text image data set S0 (Step S1). Monitoring is started as to whether or not the user has carried out a transfer instruction operation is then started (Step S2). When a result at Step S2 becomes affirmative, the text image data set S0 and the text image information C0 are sent to the text image processing apparatus 2 via the mobile phone communication network 4 (Step S3).

In the text image processing apparatus 2, the communication means 21 receives the text image data set S0 and the text image information C0 (Step S4). The correction means 22 reads the correction information corresponding to the model of the camera phone 3 from the storage means 24, and corrects the distortion of the text image caused by aberration of the camera lens or the like. In this manner, the corrected text image data set S1 is obtained (Step S5). The character recognition means 23 carries out pattern recognition on the corrected text image data set S1, and obtains the character code data set T0 representing the character codes (Step S6). The corrected text image data set S1 is stored in the storage means 24 (Step S7), and the link information generation means 25 generates the link information L0 having the URL of where the corrected text image data set S1 is stored (Step S8). The character code data set T0 and the link information L0 are sent from the communication means 21 to the camera phone 3 via the mobile phone communication network 4 (step S9).

In the camera phone 3, the character code data set T0 and the link information L0 are received (Step S10), and the text represented by the character code data set is displayed on the liquid crystal display monitor 32 (Step S11). Monitoring is started as to whether or not the user carries out a display instruction operation regarding the URL represented by the link information L0 by using the buttons 33 (Step S12). If a result at Step S12 is affirmative, the URL represented by the link information L0 is displayed in the liquid crystal display monitor 32 (Step S13) to end the process.

As has been described above, according to the first embodiment, the text image processing apparatus 2 carries out the character recognition processing on the corrected text image data set S1, and the characters included in the text image represented by the text image data set S1 are coded as the character code data set T0. The character code data set T0 is then sent to the camera phone 3. Therefore, as long as the user of the camera phone 3 photographs the characters written on the text medium such as paper or a blackboard with use of the camera phone 3, the characters can be displayed on the liquid crystal display monitor 32 as the text, without a typing operation regarding the characters. When a text image is displayed, characters therein may not be easy to see, due to image processing carried out thereon. However, since the characters can be displayed as the text in this embodiment, the problem of hard-to-see characters can be avoided.

By outputting the link information L0 of the corrected text image data set S1 obtained by correction of the text image data set S0 from which the character code data set T0 was obtained, the corrected text image data set S1 can be referred to by access to the URL represented by the link information L0. Therefore, the text image represented by the corrected text image data set S1 can be compared with the text represented by the character code data set T0, and presence or absence of an error in the character code data set T0 can be confirmed easily.

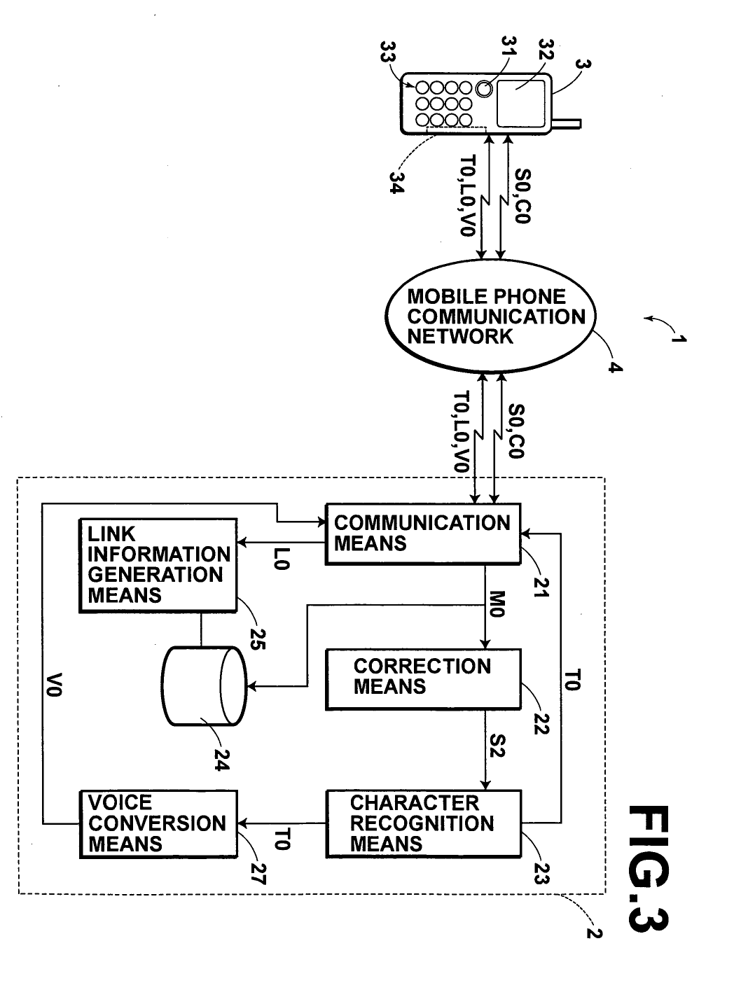

A second embodiment of the present invention will be explained next. FIG. 3 is a block diagram showing a configuration of a text image communication system adopting a text image processing apparatus of the second embodiment of the present invention. In the second embodiment, the same elements as in the first embodiment have the same reference numbers, and detailed explanations thereof will be omitted. In the second embodiment, the text image processing apparatus 2 further comprises voice conversion means 27 for converting the character code data set T0 into a voice data set V0.

The voice conversion means 27 converts the characters represented by the character code data set T0 into the voice data set V0 representing a synthetic voice that imitates a human voice. The voice (such as a man's or a woman's voice, or the voice of a famous person) may be changed by an instruction from the camera phone 3.

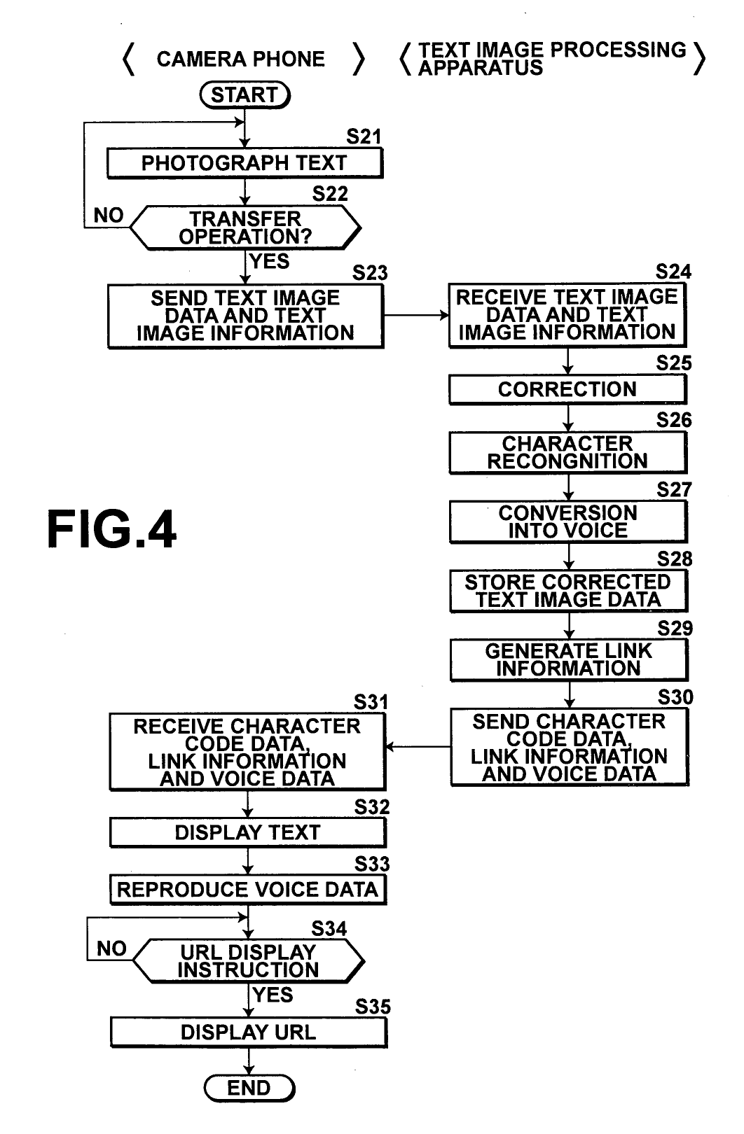

The operation of the second embodiment will be explained next. FIG. 4 is a flow chart showing procedures carried out in the second embodiment. The user photographs the characters written on the text medium by using the camera phone 3, and obtains the text image data set S0 (Step S21). Monitoring is started as to whether or not the user has carried out the transfer instruction operation (Step S22). When a result at Step S22 becomes affirmative, the text image data set S0 and the text image information C0 are sent to the text image processing apparatus 2 via the mobile phone communication network 4 (Step S23).

In the text image processing apparatus 2, the communication means 21 receives the text image data set S0 and the text image information C0 (Step S24). The correction means 22 reads the correction information corresponding to the model of the camera phone 3 from the storage means 24, and corrects the distortion of the text image caused by aberration of the camera lens or the like. In this manner, the corrected text image data set S1 is obtained (Step S25). The character recognition means 23 carries out pattern recognition on the corrected text image data set S1, and obtains the character code data set T0 (Step S26). The voice conversion means 27 converts the character code data set T0 into the voice data set V0 (Step S27).

The corrected text image data set S1 is stored in the storage means 24 (Step S28), and the link information generation means 25 generates the link information L0 having the URL of where the corrected text image data set S1 is stored (Step S29). The character code data set T0, the link information L0, and the voice data set V0 are sent from the communication means 21 to the camera phone 3 via the mobile phone communication network 4 (step S30).

In the camera phone 3, the character code data set T0, the link information L0, and the voice data set V0 are received (Step S31), and the text represented by the character code data set T0 is displayed on the liquid crystal display monitor 32 (Step S32). The voice data set V0 is also reproduced as an audible voice (Step S33). Monitoring is started as to whether or not the user carries out the display instruction operation regarding the URL represented by the link information L0, by using the buttons 33 (Step S34). If a result at Step S34 is affirmative, the URL represented by the link information L0 is displayed in the liquid crystal display monitor 32 (Step S35) to end the process.

As has been described above, according to the second embodiment, the voice data set V0 is sent to the camera phone 3 together with the character code data set T0 and the link information L0. The text represented by the character code data set T0 is displayed on the liquid crystal display monitor 32, and the voice data set V0 is also reproduced. Therefore, the text displayed on the monitor 32 is read. In this manner, the content of the text image can be understood even if the user cannot read the text.

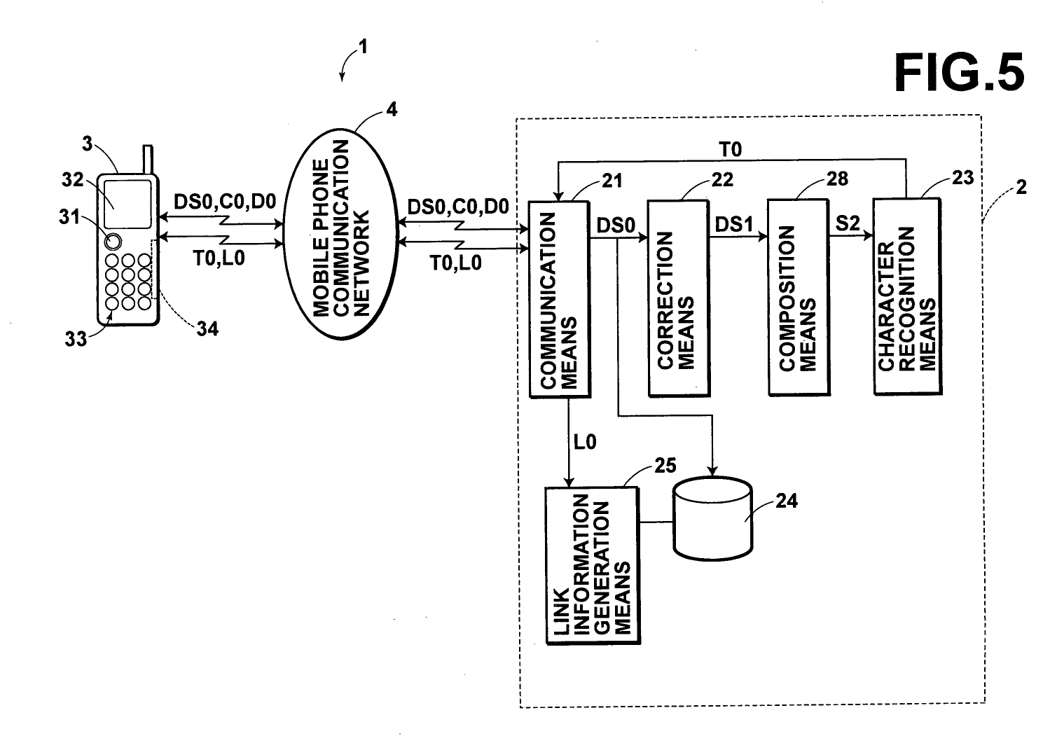

A third embodiment of the present invention will be explained next. FIG. 5 is a block diagram showing a configuration of a text image communication system adopting a text image processing apparatus of the third embodiment of the present invention. In the third embodiment, the same elements as in the first embodiment have the same reference numbers, and detailed explanations thereof will be omitted. In the third embodiment, the user of the camera phone 3 photographs the text medium such as paper or blackboard divided into several parts, and obtains partial text image data sets DS0. The partial text image data sets DS0 are sent to the text image processing apparatus 2. The partial text image data sets DS0 are corrected and corrected partial text image data sets DS1 are then generated. The corrected partial text image data sets DS1 are put together by composition means 28 to generate a text image data set S2 as a composite of the corrected partial text image data sets DS1.

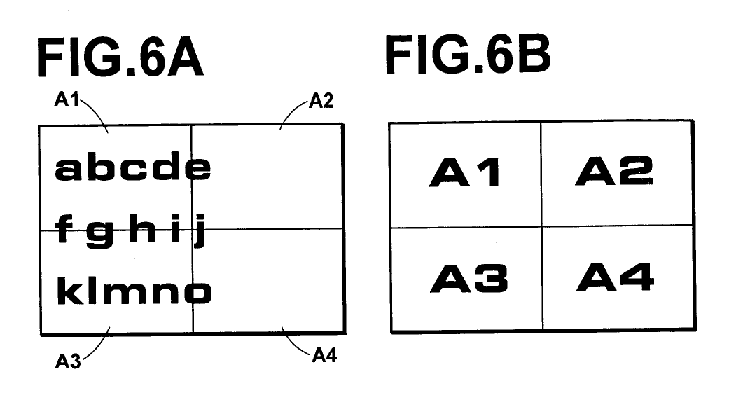

The camera phone 3 generates partition information D0 representing how the text image was photographed, and sends the partial text image data sets DS0 and the partition information P0 to the text image processing apparatus 2. FIGS. 6A and 6B show how the partition information D0 is generated. As shown in FIG. 6A, in the case where the text medium is partitioned into areas A1˜A4 to be photographed, the camera phone 3 adds information of the areas from which the partial text image data sets DS0 are obtained (such as a code like A1) to tag information of the partial text image data sets DS0. Meanwhile, as shown in FIG. 6B, the partition information D0 represents an image that shows an entire area of the text image to be restored and the code for specifying each of the partial text image data sets DS0 to be inserted in the corresponding area of the text image. The tag information is also added to the corrected partial text image data sets DS1 obtained by correction of the partial text image data sets DS0.

The composition means 28 refers to the partition information D0 and the tag information added to the corrected partial text image data sets DS1, and obtains the text image data set S2 representing the text image including the characters written on the photographed text medium by putting together the corrected partial text image data sets DS1.

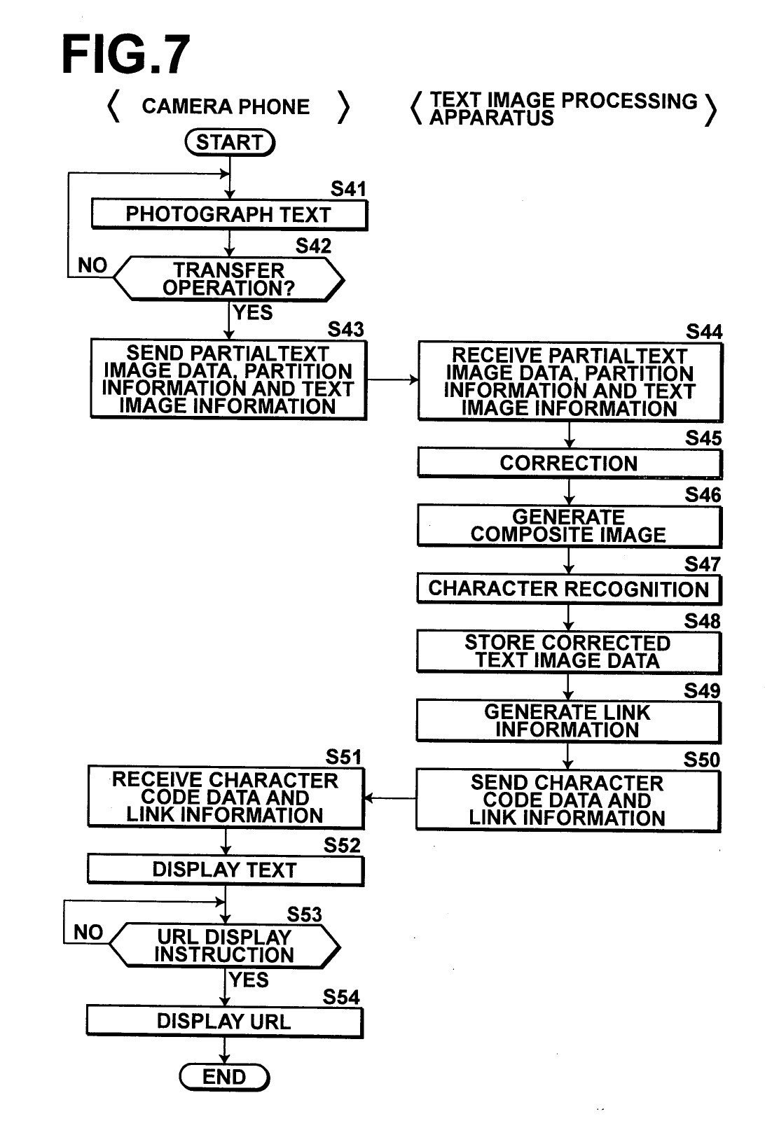

The operation of the third embodiment will be explained next. FIG. 7 is a flow chart showing procedures carried out in the third embodiment. The user using the camera phone 3 photographs the characters written on the text medium by dividing the text medium into the areas, and obtains the partial text image data sets DS0 (Step S41). Monitoring is started as to whether or not the data transfer instruction operation has been carried out (Step S42). When a result of the judgment at Step S42 becomes affirmative, the partial text image data sets DS0, the text image information C0, and the partition information D0 are sent to the text image processing apparatus 2 via the mobile phone communication network 4 (Step S43).

The text image processing apparatus 2 receives the partial text image data sets DS0, the text image information C0, and the partition information D0 by using the communication means 21 (Step S44). The correction means 22 reads the correction information corresponding to the model of the camera phone 3 from the storage means 24, and corrects the distortion of the text image caused by aberration of the camera lens or the like. In this manner, the corrected partial text image data sets DS1 are obtained (Step S45). The composition means 28 puts together the corrected partial text image data sets DS1 according to the partition information D0, and obtains the text image data set S2 (Step S46).

The character recognition means 23 carries out pattern recognition on the text image data set S2, and obtains the character code data set T0 representing the character codes (Step S47).

The text image data set S2 is stored in the storage means 24 (Step S48), and the link information generation means 25 generates the link information L0 representing the URL of where the text image data set S2 is stored (Step S49). The character code data set T0 and the link information L0 are then sent from the communication means 21 to the camera phone 3 via the mobile phone communication network 4 (Step S50).

The camera phone 3 receives the character code data set T0 and the link information L0 (Step S51), and the character code data set T0 is displayed as text on the liquid crystal monitor 32 (step S52). Monitoring is started as to whether or not the instruction for displaying the URL represented by the link information L0 is input from the buttons 33 (Step S53). If a result at Step S53 is affirmative, the URL is displayed on the liquid crystal display monitor 32 (Step S54) to end the process.

As has been described above, according to the third embodiment, the text image data set S2 is obtained as the composite of the partial text image data sets DS0 obtained by photography of the text medium divided into the areas, and the character code data set T0 is obtained by character recognition on the text image data set S2. Therefore, even if the characters are written on the text medium having a large area such as a blackboard, the characters can be obtained as the character code data set T0 by partially photographing the text medium divided into the areas.

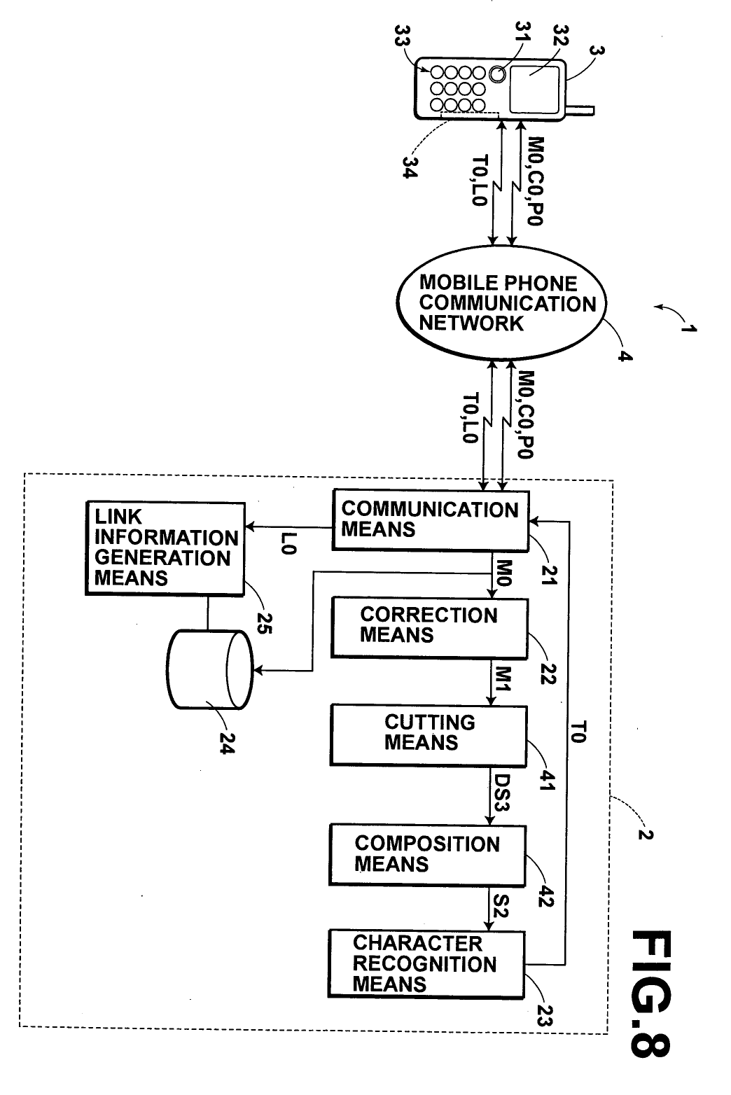

A fourth embodiment of the present invention will be explained next. FIG. 8 is a block diagram showing a text image communication system adopting a text image processing apparatus of the fourth embodiment of the present invention. In the fourth embodiment, the same elements as in the first embodiment have the same reference numbers, and detailed explanations thereof will be omitted. In the fourth embodiment, the user using the camera phone 3 obtains a moving text image data set M0 by filming the characters written on the text medium, and the moving text image data set M0 is sent to the text image processing apparatus 2 wherein character recognition is carried out. Therefore, the text image processing apparatus 2 comprises cutting means 41 for cutting from the moving text image data set M0 frame data sets DS3 that are necessary for generating a composite image representing the text image, and composition means 42 for generating a text image data set S3 by generating the composite image from the frame data sets DS3.

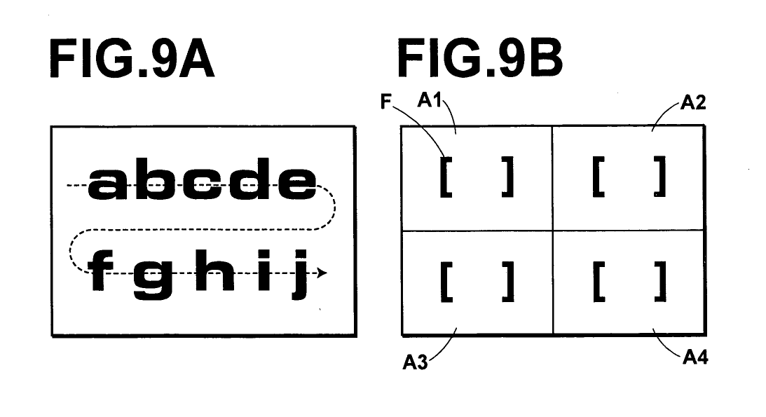

In the camera phone 3, marks that are necessary for cutting the frame data sets DS3 are added to the moving text image data set M0, and the moving text image data set M0 added with the marks is sent to the text image processing apparatus 2. FIGS. 9A and 9B show how the marks are added. As shown in FIG. 9A, the text medium is filmed as if the characters such as abcdefg written thereon are traced. In this manner, the moving text image data set M0 is obtained. During the photography, when a frame F displayed in a finder of the camera phone 3 is positioned at the center of each of the areas A1˜A4, each of the marks is added to the moving text image data M0 in response to an instruction input by the user from the buttons 33.

The cutting means 41 cuts the frames added with the marks, and generates the frame data sets DS3 that are necessary for generating the text image data set S3 as the composite image.

The composition means 42 generates the composite image from the frame data sets DS3, and obtains the text image data set S3 representing the text image including the characters written on the entire text medium.

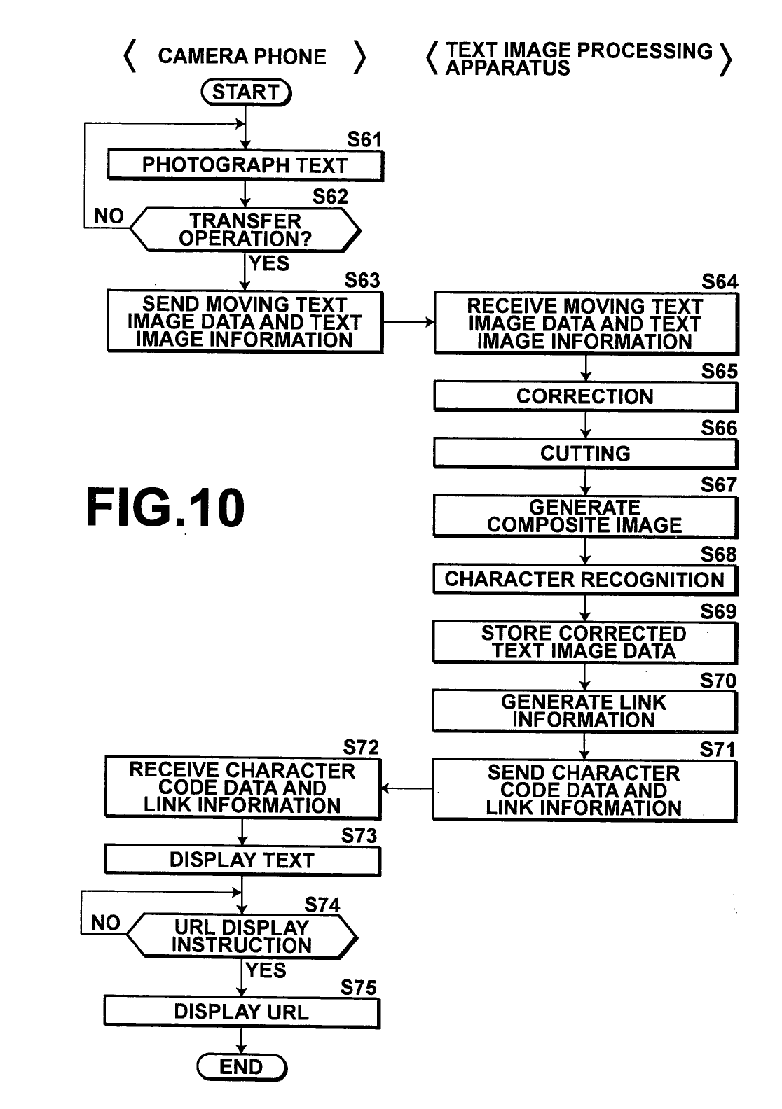

The operation of the fourth embodiment will be explained next. FIG. 10 is a flow chart showing procedures carried out in the fourth embodiment. The user of the camera phone 3 films the characters written on the text medium in the above manner, and obtains the moving text image data set M0 (Step S61). Monitoring is started as to whether or not the data transmission has been instructed (Step S62). If a result of the judgment at Step S62 becomes affirmative, the moving text image data set M0 and the text image information C0 are sent to the text image processing apparatus 2 via the mobile phone communication network 4 (Step S63).

The text image processing apparatus 2 receives the moving text image data set M0 and the text image information C0 by using the communication means 21 (Step S64). The correction means 22 reads the correction information corresponding to the model of the camera phone 3 from the storage means 24, and corrects the distortion of the text image caused by aberration of the camera lens or the like. In this manner, a corrected moving text image data set M1 is obtained (Step S65). The cutting means 41 cuts the frame data sets DS3 from the corrected moving text image data set M1, according to the marks added to the corrected moving text image data set M1 (Step S66). The composition means 42 puts together the frame data sets DS3, and obtains the text image data set S3 as the composite thereof (Step S67).

The character recognition means 23 carries out pattern recognition on the text image data set S3, and obtains the character code data set T0 representing the character codes (Step S68).

The text image data set S3 is stored in the storage means 24 (Step S69), and the link information generation means 25 generates the link information L0 representing the URL of where the text image data set S3 is stored (Step S70). The character code data set T0 and the link information L0 are then sent from the communication means 21 to the camera phone 3 via the mobile phone communication network 4 (Step S71).

The camera phone 3 receives the character code data set T0 and the link information L0 (Step S72), and the character code data set T0 is displayed as text on the liquid crystal monitor 32 (step S73). Monitoring is started as to whether or not the instruction for displaying the URL represented by the link information L0 is input from the buttons 33 (Step S74). If a result at Step S53 is affirmative, the URL is displayed on the liquid crystal display monitor 32 (Step S75) to end the process.

As has been described above, according to the fourth embodiment, the frame data sets DS3 are cut from the moving text image data set M1 obtained by filming the text medium, and the text image data set S3 to be subjected to the character recognition is obtained by generating the composite image from the frame data sets DS3. Therefore, even if the characters are written on the text medium having a large area such as a blackboard, the characters can be obtained as the character code data set T0 by filming the text medium.

In the third and fourth embodiments of the present invention, the voice conversion means 27 may be installed in the text image processing apparatus 2, as in the second embodiment, so that the voice data set V0 obtained by conversion of the character code data set T0 can be sent to the camera phone 3.

In the first to fourth embodiments described above, in the case where the characters are often written by the same person, characteristics of handwriting of the person are preferably stored in the storage means 24. In this case, information for identifying the person is also sent to the text image processing apparatus 2 together with the text image data set S0 or the like, and the text image processing apparatus 2 obtains the character code data set T0 by using the character recognition means 23 in consideration of the characteristics, based on the information.

By considering the characteristics of the handwriting of the person who wrote the characters, accuracy of the character recognition by the character recognition means 23 can be improved.

In the first to fourth embodiments described above, the camera phone 3 photographs the text medium. However, the text medium may be photographed by any camera-embedded mobile terminal, such as a camera-embedded PDA and a digital camera having a communication function, for generating the text image data set. The text image data set is sent to the text image processing apparatus 2, and the mobile terminal displays the character code data set T0 as text.

What is claimed is:

1. A text image processing method comprising the steps of:
receiving an input of a text image data set representing a text image obtained by photography of a text medium on which characters are written;
obtaining a character code data set by converting the characters included in the text image into codes through character recognition processing on the text image data set; and
outputting the character code data set.

2. The text image processing method according to claim 1, further comprising the step of obtaining the text image data set as a composite of partial text image data sets obtained by partially photographing the text medium while dividing the text medium into parts.

3. The text image processing method according to claim 1, further comprising the steps of;
cutting predetermined frames from a moving image data set obtained by filming the text medium; and
generating the text image data set as a composite of frame image data sets representing the predetermined frames.

4. The text image processing method according to claim 1, further comprising the steps of:
storing the text image data set; and
outputting link information representing where the text image data set is stored, together with the character code data set.

5. The text image processing method according to claim 1, further comprising the steps of:
converting the character code data set into a voice data set; and
outputting the voice data set instead of or together with the character code data set.

6. The text image processing method according to claim 1, further comprising the steps of:
receiving the text image data set obtained by photography of the text medium with a camera-embedded mobile terminal and sent from the camera-embedded mobile terminal; and
sending the character code data set to the camera-embedded mobile terminal.

7. A text image processing apparatus comprising:
input means for receiving an input of a text image data set representing a text image obtained by photography of a text medium on which characters are written;
character recognition means for obtaining a character code data set by converting the characters included in the text image into codes through character recognition processing on the text image data set; and
output means for outputting the character code data set.

8. The text image processing apparatus according to claim 7, further comprising composition means for obtaining the text image data set through generation of a composite image from partial text image data sets obtained by partially photographing the text medium while dividing the text medium into parts.

9. The text image processing apparatus according to claim 7, further comprising:
cutting means for cutting predetermined frames from a moving image data set obtained by filming the text medium; and
composition means for obtaining the text image data set through generation of a composite image from frame image data sets representing the predetermined frames cut by the cutting means.

10. The text image processing apparatus according to claim 7, further comprising:
storage means for storing the text image data set; and
link information generation means for generating link information representing where the text image data set is stored, wherein
the output means outputs the link information together with the character code data set.

11. The text image processing apparatus according to claim 7, further comprising voice conversion means for converting the character code data set into a voice data set, wherein
the output means outputs the voice data set instead of or together with the character code data set.

12. The text image processing apparatus according to claim 7, further comprising communication means for receiving the text image data set obtained by photography of the text medium with a camera-embedded mobile terminal and sent from the camera-embedded mobile terminal, and for sending the character code data set to the camera-embedded mobile terminal.

13. A program for causing a computer to execute a text image processing method, the program comprising the steps of:
receiving an input of a text image data set representing a text image obtained by photography of a text medium on which characters are written;
obtaining a character code data set by converting the characters included in the text image into codes through character recognition processing on the text image data set; and
outputting the character code data set.

14. The program according to claim 13, further comprising the step of obtaining the text image data set as a composite of partial text image data sets obtained by partially photographing the text medium by dividing the text medium into parts.

15. The program according to claim 13, further comprising the steps of;
cutting predetermined frames from a moving image data set obtained by filming the text medium; and
generating the text image data set as a composite of frame image data sets representing the predetermined frames cut by the cutting means.

16. The program according to claim 13, further comprising the steps of:
storing the text image data set; and
outputting link information representing where the text image data set is stored, together with the character code data set.

17. The program according to claim 13, further comprising the steps of:
converting the character code data set into a voice data set; and
outputting the voice data set instead of or together with the character code data set.

18. The program according to claim 13, further comprising the steps of:
receiving the text image data set obtained by photography of the text medium with a camera-embedded mobile terminal and sent from the camera-embedded mobile terminal; and
sending the character code data set to the camera-embedded mobile terminal.
